(19) United States
(12) Patent Application Publication
(10) Pub. No.: US 2006/0147584 A1
(43) Pub. Date: Jul. 6, 2006

(54) Aerated chocolate with microbubbles for improved stability

(75) Inventor: Andre Robert, Wendouree (AU)

Correspondence Address: FITZPATRICK CELLA HARPER & SCINTO, 30 ROCKEFELLER PLAZA, NEW YORK, NY, 10112, US

(73) Assignee: Mars Incorporated, McLean, VA (US)

(21) Appl. No.: 10/540,260

(22) PCT Filed: Dec. 23, 2003
(86) PCT No.: PCT/AU03/01709

§ 371 Date: Jan. 10, 2006

(30) Foreign Application Priority Data
Dec. 23, 2002 (AU) 2002327081

(51) Int. Cl. A23L 1/36

(52) U.S. Cl. 426/93

(57) ABSTRACT

A confectionery product comprising low density chocolate surrounded by a sugar-based coating, and a process for producing the confectionery product. The confectionery product is shelf stable, even at elevated ambient temperatures.

### FIELD OF THE INVENTION

This invention relates to the production of chocolate confectionery, in particular confectionery that comprises a chocolate core surrounded by a sugar-based shell.

### BACKGROUND OF THE INVENTION

Various confectionery products are known which incorporate chocolate within an outer sugar-based coating or shell. Such products include M&M's® (of Effem Foods) and SMARTIES® (of Nestle) and other similar confectionery products. These products have enjoyed wide consumer appeal and vast quantities of these products have been sold throughout the world.

One problem of some such confectionery products is maintaining shelf stability at elevated ambient temperatures. At elevated ambient temperatures, the internal chocolate melts and expands, which can cause the coating, or shell, to crack. The internal, molten chocolate can then ooze out through the cracks which disfigure the confectionery product. This significantly reduces the consumer appeal and, therefore, the value of the products. The limited shelf stability at elevated ambient temperatures of these types of confectionery products has limited the commercial success of such products in countries having warmer climates and/or where air-conditioning is not widespread. This lack of shelf stability at elevated ambient temperatures can limit the market appeal of such confectionery products as, in hot weather or when exposed to direct sunlight, the coating can crack and the inner chocolate ooze out.

A variety of means have been attempted to produce a commercially acceptable confectionery, having a chocolate centre and a sugar shell, for hotter regions of the world. Some of the methods involve altering the ingredients of the chocolate centre, others involve treatment of the shell and others, treatment of both the chocolate centre and the sugar shell.

Approaches that involve treatments of the sugar shell include varying shell configurations and formulations aimed at making the shell more pliable and resistant to increased internal pressure.

U.S. Pat. Nos. 2,480,935 and 2,760,867 describe attempts to impart heat stability to chocolate by enveloping the confection in a sugar-crystal mat. This sugar-crystal mat is induced from sugar bloom and is created by dissolving sugar crystals on the surface of the confection. The sugar syrup is then dried, producing a surface mat of intertwined crystals encasing the confection. By doing so, the confection does not “oil off” when held at temperatures above the melting point of fat.

U.S. Pat. No. 2,487,931 involves dissolving sugars at elevated temperatures and crystallisation of the sugars when the chocolate mass is cooled to room temperature. The resultant confectionery does not deform at any temperature below the charring point of sugar.

In a different attempt at increasing shelf stability at higher ambient temperatures, higher melting point fats have also been added to the chocolate formulation in the past. However, this can result in chocolate having an undesirable taste or texture.

Attempts have been made to make the chocolate centre more robust by adding water to the centre, which establishes a sugar rather than fat matrix as the backbone of the chocolate structure. Such attempts have resulted in a chocolate centre that melts at much higher temperatures. However, turning this concept into a commercial reality has proven to be difficult due to the rheological change of the chocolate that takes place (One such change is the dramatic increase in the yield stress of the water added chocolate). Numerous patents have been granted for inventions directed to making chocolate stable at temperatures above the typical melting points of the fats in milk chocolate, by adding water to chocolate, causing amorphous sugars to crystallise, or using noncrystallising amorphous sugars. For example, U.S. Pat. No. 5,149,560 involves creating a stable water-in-oil emulsion, for example, a hydrated lecithin, and then adding the emulsion to tempered chocolate to form a heat-stable chocolate. Swiss Patent No. 662041 concerns spraying water directly into mixing chocolate. The chocolate necessarily contains milk powder. Japanese Patent No. 60-27339 involves imparting heat resistance to chocolate by adding a water-in-oil emulsion just prior to enrobing or moulding. U.S. Pat. No. 4,446,166 involves creating heat-resistant chocolate by mixing into chocolate a water-in-fat emulsion. U.S. Pat. No. 2,480,935 concerns adding water to chocolate directly, just prior to moulding or enrobing. An emulsifier is recommended to assist in the addition of water to the chocolate. It is considered that heat resistance requires a maximum of 35% fat.

Yet another way to increase shelf stability at higher ambient temperature of sugar shell coated chocolate centers involves the use of “aerated” chocolate. This approach is based on the recognition that, during a phase change from the solid polymorphic state to the liquid chocolate state, and when the chocolate is located within an outer, relatively rigid coating (or shell), the expansion in volume of the chocolate can be accommodated by compression of gas bubbles within the confectionery product core rather than expanding beyond the volume defined by the coating. For example, U.S. Pat. No. 5,004,623 involves mixing a foam into tempered chocolate paste, and stabilising the foam with either emulsifiers or with a protein to form a heat stable chocolate. JP-A 965830 of Meiji Seika Kaisha Ltd describes glycocalyx covered chocolate centers, where the chocolate incorporates air bubbles, an aerated liquid or foamed solids thereby to reduce the overall density of the centers.

There is patent literature that deals with machinery and processes for producing aerated chocolate, such as for example PCT/GB00/02184 that relates to a tempering and aerating machine assembly for producing chocolate and couverture coatings that contain bubbles of air, and PCT/GB00/04008 that relates to a confectionery (here: chocolate) aeration system with re-circulation circuit that is said to provide better control of the aeration process than the more commonly employed air injection into a conventional chocolate mass depositor hopper. The re-circulation circuit with integrated aerator is said to enable a relatively high degree of aeration whilst recirculation progressively reduces the size of the gas bubbles in the recirculated chocolate and thus improves the appearance of the deposited material. WO 00/64269 (PCT/GB00/01555) also describes a process for producing an aerated chocolate coating that employs a coating head with re-circulation circuit and aerator, where the rate of injection of gas into the chocolate is controlled in response to a measure of the density of the chocolate material in the re-circulating circuit prior to supply to the coating head. As is the case with the other mentioned PCT documents, the aeration circuit is intended to generate bubbles of microscopic size in the chocolate which is being supplied from a tempering unit. None of the documents provide data about the specific size and distribution of bubbles within the chocolate, and WO 00/64269 alludes to potential problems that may result from agglomeration of micro-bubbles into visible bubbles where re-circulation is not accomplished for all of the aerated and tempered liquid chocolate. Recirculation is identified as necessary to create micro bubbles.

Most equipment in chocolate manufacturing lines is very specific to the type of confectionery being produced and therefore not readily transferable from one production line to another. The aforementioned PCT documents provide good example of this in that the machinery and processes are described there as relating to aeration of chocolate coatings only. Indeed, WO 01/15543 which cross-references to PCT/GB00/1555), describes a (confectionery) product that has a non-aerated chocolate coating over an aerated chocolate coating that surrounds a core or center and which is produced using the methodology and machinery described in PCT'1555. None of the PCT documents allude to shelf stability of aerated chocolate nor what aspects of process technology may have to be considered in using the described technology in the manufacture of sugar shelled chocolate cores/centers, beyond the fact that non-aerated chocolate generally melts less easily than aerated chocolate, which at first glance would suggest not to use aerated chocolate in applications where higher ambient temperatures could cause undesired chocolate melting.

International Patent Application No. PCT/AU01/00452 describes a shelf-stable confectionery product comprising low density, tempered chocolate surrounded by a sugar-based coating. The density of the chocolate core of International Patent Application No. PCT/AU01/00452 is in the range of about 0.6 to 1.25 g/ml. That low density chocolate is made by traditional tempering of the chocolate mix (typically in a temper kettle) and then reducing the density by incorporating gas bubbles into the tempered chocolate mix. The gas is incorporated by stirring of the tempered chocolate mix whilst pumping gas into the chocolate mix.

In manufacturing sugar coated (shell) chocolate centers (such as M&M's®) using aerated chocolate as produced by the process described in PCT/AU01/00452 it has been found that the final product exhibits an undesired percentage of shape irregularities, the desired shape being a lenticular body with smooth and regular convex (top and bottom) surfaces and uniform curvature at the waist or greatest diameter location of the confectionery bodies. Whilst Smarties and M&M's made with non-aerated chocolate centers also exhibit a certain (lower) percentage of ill-shaped individual confectionery pieces, the aim of achieving good and uniform product appearance is important from a consumer appeal point of view. Given the many variables in the manufacturing process at each stage, and the interrelationship that exists between some of these, eg temper state at aeration, temperature profile at moulding the chocolate centers, roller mould rotation speeds, cooling tunnel length, etc, it will be appreciated by the skilled worker that seeking to rectify product shaping problems is not merely a trial and error exercise.

### OBJECTS OF THE INVENTION

It is an object of the invention to provide an improved confectionery product having an aerated chocolate centre and sugar-based shell coating, which has improved shelf stability at elevated ambient temperatures compared to existing such confectionery products that incorporate non-aerated chocolate centers. Within this aim, the invention seeks to decrease (statistically) the number of irregularities in the lenticular shape of the chocolate centers and the surrounding sugar shell of such panned chocolate confectionery.

It is a further object of the invention to provide a method for manufacturing a shelf stable confectionery product having an aerated chocolate centre and a sugar-based shell coating.

The present invention is particularly aimed at improving confectionery products having a low density chocolate core within a sugar-based outer coating shell, without having to modify the chemical composition of the chocolate core or the coating.

### SUMMARY OF THE INVENTION

It has been surprisingly found that by omitting a specific tempering stage that uses a temper-kettle or similar before aeration of the liquid chocolate mixture, such as in the process described in PCT/AU01/00452 (as well as the other WO/PCT prior art documents referred to above), and controlling processing of the chocolate mixture in the aeration device such as to achieve a predetermined (mean) maximum gas bubble size, a confectionery product having the desired shelf and heat stability with improved (average) shape quality can be produced.

In aerated chocolate processed in accordance with the present invention, there is less variation of bubble size throughout the chocolate mix and the chocolate cores once such are moulded. On average, the bubble size throughout the chocolate mix at the time of moulding is smaller than that achieved using the process of PCT/AU01/00452, and the bubbles have a more homogeneous distribution. This bubble arrangement results in an aerated chocolate mix of more constant rheology than the chocolate produced using the teachings of PCT/AU01/00452. It is believed that the smaller average bubble size aids in creating better-shaped cores at the moulding and setting stage of confectionery manufacture, as the material strength of the formed centers would be greater than where larger size bubbles and/or bubble size ranges are present in the aerated chocolate.

As noted, there is no specific tempering step or process carried out on the pasty or liquid chocolate mixture prior to or after aeration. However, tempering of the moulded and set aerated chocolate will still take place, as has been noticed on trial batches of products manufactured in accordance with the inventive process, but via the tempering process known as ‘Oswald ripening’. Instead of using a dedicated temper kettle or similar device, use of an aeration device that incorporates a mechanical mixing head (see below) will destroy unstable (fat) crystals mechanically, and it is believed that during and after the center forming stage that the micro bubbles act as (fat) crystallisation nucleation sites, accelerating the temper process.

In light of the above, in a first aspect of the invention, there is provided a shelf-stable confectionery product comprising a chocolate core and a sugar-based coating, characterised in that the chocolate core is dispersed with gas bubbles having an average diameter of less than 25 microns. Typically, the average diameter of the gas bubbles is about 17 microns. The dispersion is preferably homogeneous through out the core. The confectionery product is preferably a sugar panned product.

According to a second aspect of the invention there is provided a process for making a shelf-stable confectionery product having a chocolate core and a sugar-based shell coating, characterised in that the process includes the steps (a) to (f), in the specified order:

a) preparing a pasty or liquid chocolate mix from solid chocolate making ingredients and at least one fat;

b) cooling said chocolate mix to form a cooled chocolate mix;

c) transferring said cooled chocolate mix into a mixing chamber;

d) in said mixing chamber, incorporating gas into said chocolate mix and stirring the so aerated chocolate mix to form a low density chocolate with micro gas bubbles having an average size no greater than a predetermined value;

e) extruding the low density chocolate onto one or more chilled moulding rolls and solidifying said low density chocolate into a desired shape;

f) coating said moulded, low density chocolate with a sugar-based coating to form said shelf-stable confectionery product.

In a third aspect of the invention there is provided a confectionery product manufactured using the steps (a) to (f), in the specified order, mentioned above.

In a further aspect, the invention provides a process of manufacturing aerated chocolate, wherein after a chocolate mixture has been formed by mixing solid chocolate making ingredients with at least one fat, the pasty or liquid chocolate mixture is transferred without undergoing a tempering step in a temper-kettle or similar device, into an aeration device with mechanical mixing means, wherein a gas such as air is delivered to the aeration device where it is incorporated into the chocolate mixture, and wherein the chocolate mixture is agitated in the aeration device such as to achieve a predetermined (mean) maximum gas bubble size in the resulting aerated chocolate mixture prior to it being discharged from the aeration device for further processing.

The density of the chocolate core obtained using the process of the present invention is lower than the density of the chocolate core of similar types of “non-aerated” prior confectionery products, such as SMARTIES® and earlier types of M&M's® (which typically had a density of about 1.28-1.31 g/ml) and hence the chocolate is referred to as “low density” chocolate.

Definitions

The following terms have the meanings given below:

“Chocolate” as used herein is intended to cover conventional chocolates as defined by the different national regulations governing this term, that is those which contain cocoa mass (or powder), cocoa butter, sugar and optionally milk and flavourings, as well as the so-called “white” chocolates which do not contain cocoa mass or powder. The term is also intended to include products containing cocoa and a fat other than cocoa butter. For example, the chocolate may be “white” chocolate, “dark” chocolate, “milk” chocolate, compound mixture and/or mixtures thereof. In addition, the chocolate can have one or more non-chocolate additive, or inclusion such as nuts, or a flavouring.

“Shelf-stable” means that the confectionery is stable even at elevated ambient temperatures. That is, the sugar based coating does not show, or shows limited, disfiguring changes, such as cracking or oozing of the chocolate centre out of the confectionery coating, after having been subjected to elevated ambient temperatures where chocolate melts.

“Low density” or “aerated” chocolate is a chocolate comprising voids or bubbles within the chocolate, the voids being formed using air or another gas commonly employed in aerated foodstuff manufacture.

“Chocolate mix” refers to the mixture of solid chocolate making ingredients such as sugar, milk solids, cocoa solids, and the matrix-forming fat(s), such as cocoa butter, which make up the mixed chocolate ingredients in paste or liquid form before aeration.

“Comprises/comprising” and grammatical variations thereof are to be taken to specify the presence of stated features, integers, steps or components or groups thereof, but do not preclude the presence or addition of one or more other features, integers, steps, components or groups thereof.

Other aspects and further features of the present invention will also be referred to in the following description of preferred embodiments of the invention, part of which is provided with reference to the accompanying drawings.

### BRIEF DESCRIPTION OF THE DRAWINGS

FIG. 1 is a schematic diagram showing an embodiment of the process according to the invention.

FIG. 2 is a schematic diagram showing a preferred embodiment of the process according to the invention.

FIG. 3 is a schematic diagram showing another preferred embodiment of the process according to the invention.

FIG. 4 is a graph comparing heat stability test results of a product made in accordance with the invention, a product made in accordance with the teachings contained in PCT/AU01/00452, and “non-aerated” panned chocolate products.

FIG. 5 is a “box and whisker” visual representation comparing the percent change in weight at elevated temperatures of the product of the invention, the product made in accordance with PCT/AU01/00452, and a “non-aerated” product.

### DETAILED DESCRIPTION OF THE INVENTION

In the following, a general outline of the main aspects of the invention will be provided, before describing preferred embodiments thereof.

The chocolate mix used in the present invention generally comprises standard chocolate-making ingredients known in the art, see for example Beckett, Industrial Chocolate Manufacture and Use, 3^{rd} edition (1999), publishers Blackwell Science. Typically, the chocolate mix would be made up of cocoa butter in the range of about 20-50% by weight, cocoa solids (mass), milk and sugar powders, and flavours. As discussed above, it is also possible to include one or more additive, inclusion or flavourant.

The low density chocolate is formed by incorporation of gas pockets (bubbles) into the chocolate mix, thus creating an “aerated” chocolate mix. The gas may be selected from air, N₂ or CO₂, although for the purposes of the present invention, air has been found to be the most appropriate. Typically, the air is provided in the form of compressed air.

To effect this aeration, the chocolate mix and the gas are led to a mixing chamber of an aerator via pipes. The pipes are usually jacketed at a predetermined temperature. In addition, the mixing chamber itself is jacketed to maintain a predetermined temperature within the device. Preferred jacketing is by means of water or glycol/water, in particular food-grade glycol.

The chocolate mix is cooled usually to about 29° C.-31° C., and for the process of the invention preferably maintained at around 30.3° C.±0.1 before entering the mixing chamber. This cooling is achieved by passing the chocolate mix through one or more heat exchangers, typically a scraped surface heat exchanger, that can be single or multi pass. The preferred scraped surface heat exchanger is of single pass type.

The gas is incorporated into the chocolate mix by pumping of the gas and chocolate mix into the mixing chamber together with rapid mixing of the chocolate mix and gas in the chamber. It is preferred to add the gas at a rate of about under, or half, the rate at which the chocolate mix is added to the mixing chamber. If the mixing action is not sufficiently rapid, the gas will leave the resulting chocolate/gas mixture when it is exposed to the ambient environment. A preferred type of mixer is a rotor-stator type of mixing head, in particular a high-sheer rotor-stator mixing head, although other mixers known in the art such as a low shear rotor stator mixing heat, a planetary whipper or b-votator would also adequately incorporate the gas into the chocolate.

When a high shear rotor-stator mixing head is used, the rotor preferably moves at above about 49±1 revolutions per minute. The maximum rotor-stator speed is about 130 revolutions per minute. During mixing, the chocolate/gas mixture would usually heat up and thus the cooling jacket is required to ensure that the outlet temperature of the chocolate/gas mixture is approximately equal to the inlet temperature. The mixing chamber is cooled such that the chocolate, with micro gas bubbles incorporated therein, leaves the mixing chamber at no more than about 33° C.

The chocolate, which has small bubbles of gas incorporated therein, is referred to herein as “low density chocolate”.

The aeration and mixing parameters are controlled such that the aerated chocolate mix will only include micro bubbles that have an average bubble size of less than 25 microns, preferably about 17 microns. This can be achieved by optimising chocolate mix retention times within the aerator device and mixer rotor speeds, the latter depending on the type of mixing mechanism being employed. Achieving a homogeneous distribution of bubbles is also important, as this will minimise the agglomeration of the micro bubbles to form larger bubbles. In contrast, the original process described in PCT/AU01/00452 did not address the need to control mean bubble size in the aerated chocolate mix to achieve an improved shape of the formed (solidified) chocolate core of the finished confectionery.

It will be noted from the above, that there is no separate tempering step effected on the chocolate mix prior to or after aeration.

The low density chocolate is then moulded to the desired shape and size. A preferred shape is the known bi-convex, lenticular shape known from M&M's or Smarties. A preferred size is “bite-size”, that is, a piece (or several pieces) which may be put whole into a consumer's mouth. Clearly, however, any desired shape or size would fall within the scope of the invention.

Moulding may be by any process known in the art used to mould confectioneries that incorporate an outer sugar based shell. In a preferred method, a slab of the low density chocolate is deposited onto chilled moulding rolls. The slab is deposited such as to have approximately constant thickness. The moulding rolls are at a temperature low enough to ensure that the final moulded shapes, after sifting (to remove flashing) and rolling (to smooth edges) are hard enough to withstand the sugar-coating process. Typically, the temperature of the chilled moulding rolls is in the range −18 to −15° C., preferably −18±1° C.

Typically, the sifting and rolling occur simultaneously in a rotating sieve, although these procedures could be carried out separately.

The moulded shapes are then coated with a sugar-based coating by conventional means. The sugar-based coating may comprise one or more sugar-based layers. Preferably, more than one sugar-based layer is applied using a lamination process. Most preferably, at least one layer comprising sugar and water is applied, followed by layers comprising sugar, water and colours. It is usual in such a process to allow each layer to dry before adding the next layer. This layering process is repeated as many times as is required, depending on the final desired shell thickness. The final shell thickness is typically about 10-50% by weight of the confectionery and is desirably of even thickness throughout. It is usual to polish the finished confectionery before packaging. Printing may be added to the polished surface, and different coloured confectionery pieces blended together.

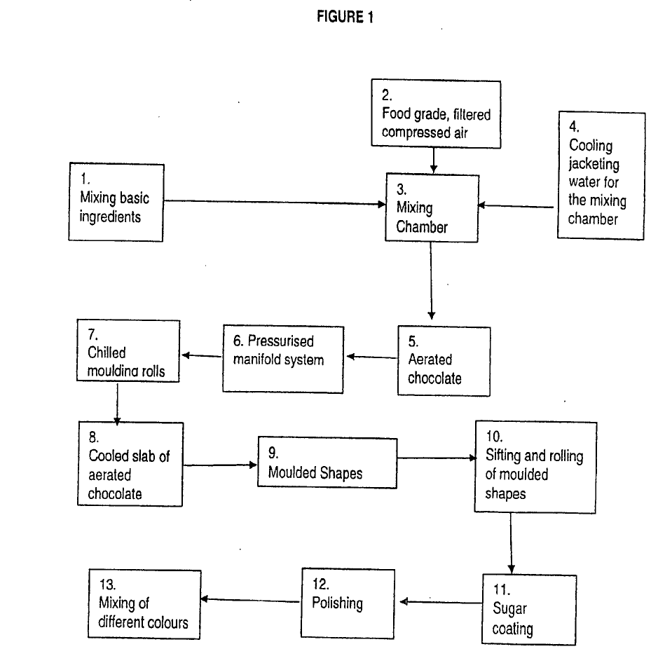

FIG. 1 shows a schematic diagram of an embodiment of a process for manufacturing bite-sized, sugar coated (shelled) chocolate centers (such as M&M's) employing the inventive process generically described above. The basic chocolate ingredients are mixed to form a chocolate mix (1). The chocolate mix (1) and food grade, filtered, compressed air (2) are fed into a mixing chamber of an aerator device (3). The compressed air (2) is delivered at a pressure higher than the pressure in the mixing chamber. The pipework to the mixing chamber and the mixing chamber itself is cooled with jacketing water (4) to ensure that the outlet temperature of the aerated chocolate leaving the mixing chamber is equal to, or only slightly above, the inlet temperature of the chocolate mix/air. In this preferred embodiment, the aerator incorporates in its mixing chamber a rotor-stator mixing head which “mixes” the compressed air into the chocolate by a whipping-type of action. This whipping action incorporates bubbles of air into the chocolate to form aerated chocolate (5), whereby this action is controlled to reduce the size of larger air bubbles to achieve statistically uniformly sized micro bubbles as described above.

The aerated chocolate is then pumped into an adjustable high-pressure manifold (6), from which it is deposited onto chilled moulding rolls (7). The chilled moulding rolls have a heated wedge in the rolls to overcome the increased yield stress of the aerated chocolate. A cooled slab of the aerated chocolate is formed (8), which is then moulded into shapes (9). The moulded shapes are then sifted and rolled (10), followed by coating with several coats of sugar-based coating (11), thereby forming the confectionery according to the invention. The pieces of confectionery may then be polished (12). Different colours of the confectionery pieces can then be mixed together (13).

In the process of FIG. 1 above, the chocolate mix is cooled to about 30.3±0.1 before being fed into mixing chamber (3). By cooling the chocolate mix, the mixing head speed can be increased, which results in an increase of number of and smaller-sized, bubbles of air.

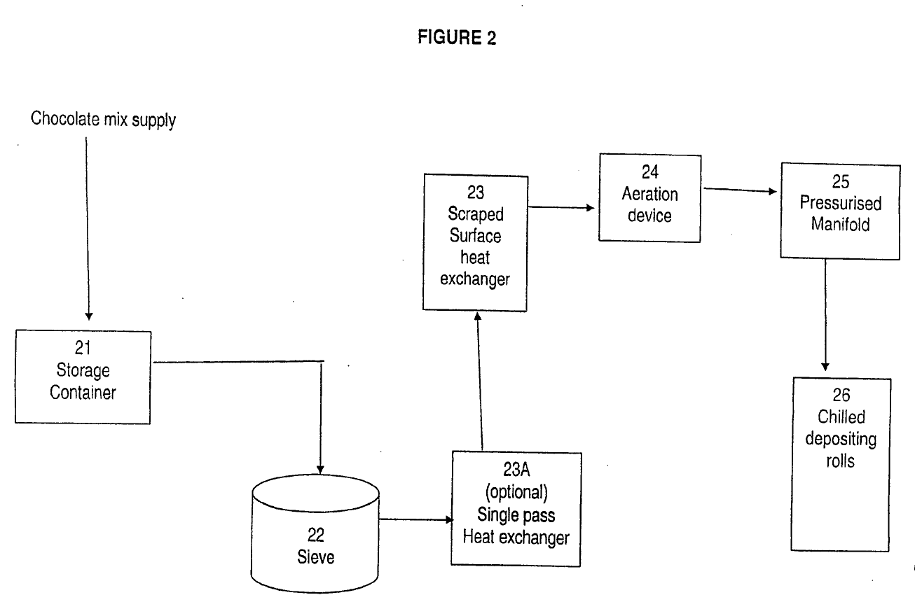

Yet another preferred embodiment of the above-described process is shown in FIG. 2. In this preferred embodiment the chocolate mix is pumped from a storage container (21) into a sieve (22) and then through a scraped surface heat exchanger (23) into an aeration device (24) where aeration of the chocolate mix takes place. After the aeration device (24), the aerated chocolate mix is fed to a pressurised manifold (25), from where the aerated chocolate mix is deposited into a set of chilled depositing rolls (26). In this preferred embodiment, the temperature of the chocolate mix when it leaves the storage container (21) is usually >45° C., and after passing through the scraped surface heat exchanger (23) the temperature of the chocolate mix is in the region of 30.3° C.±0.1. In yet another preferred embodiment, a second heat exchanger (23A) can be included before the scraped surface heat exchanger (23). The second heat exchanger (23A), typically a single pass heat exchanger, assists in cooling the chocolate mix a certain amount before entering the scraped surface heat exchanger (23). Thus the chocolate mix is passed from the sieve (22) through two heat exchangers (23A) and (23) before being fed into the aeration device (24). By increasing the mixer head speed to above about 70 rpm in the aeration device (24), smaller bubbles of gas having a more homogeneous distribution throughout the chocolate, and in the final chocolate core, than in the process disclosed in International Patent Application No. PCT/AU01/00452 are achieved.

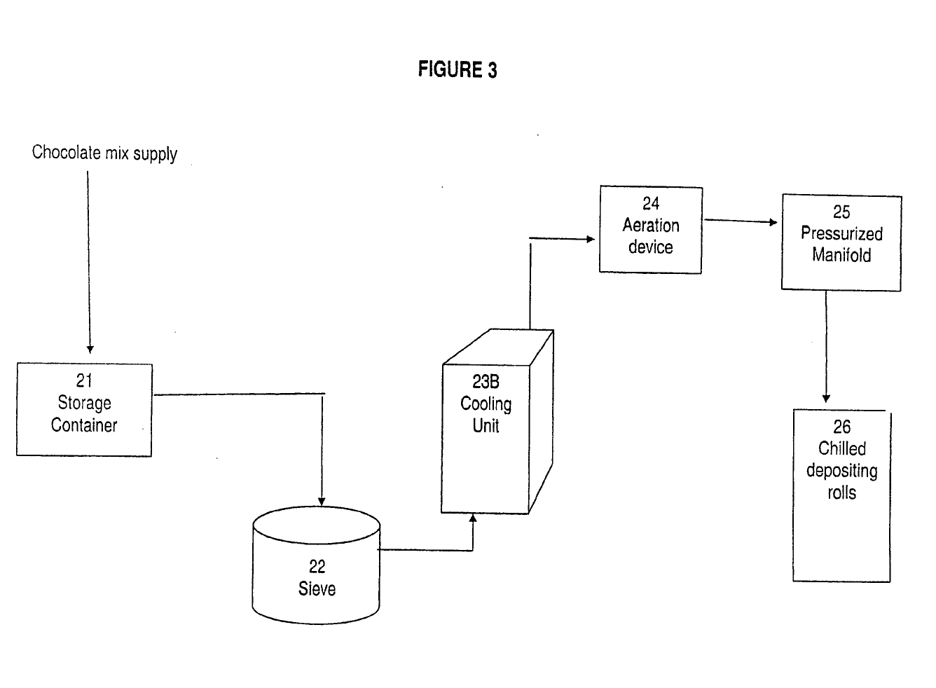

In yet a further embodiment, the heat exchanger (23) or heat exchangers (23) and (23A) can be replaced by a cooling unit (23B) which has several cooling zones which cool the chocolate mix to a specified temperature. This preferred embodiment is represented in FIG. 3.

Tests show the finished confectionery to be shelf stable, even up to 60-65° C. In typical warmer climates, for example at about 35-40° C., the degree of cracking, disfigurement and oozing out of the chocolate centre and/or fat bleed is minimal, if it occurs at all. Even if the finished product is dropped and the shell cracks as a result of this, limited, if any, oozing form the chocolate centre occurs. Furthermore, even at temperatures up to about 60° C., the majority of the confectionery products show no oozing or fat bleed. The confectionery has the desired taste, texture and mouthfeel. In addition, it has been found that there are less irregularities in the shapes of the product produced by the present invention than similar prior art products, including those made in accordance with the process described in PCT/AU01/00452. It is believed that this improved regularity in final product is due to smaller bubbles which are more evenly distributed throughout the chocolate mix than in these prior art products.

A specific, sugar panned chocolate confectionery made in accordance with the invention will now be described with reference to the following example, which is not intended to limit the scope of the invention.

### EXAMPLE

Manufacture of Chocolate

Firstly, mixtures of milk and sugar powders are refined. Powdered flavours are then added to this mixture. The powders are then added to controlled amounts of liquid fats within a pin mixer. Typically, a fat content of between 20%-50% is maintained, with a hard to soft fat ratio between 2-5. After the refining of powders and the mixing of the powders and liquids, the majority of particle sizes occur between about 20-75 microns. The temperature of the chocolate mix at this stage is in the range of about 45° C.

The chocolate mix is then passed through a sieve, and then into the cooling unit. The first zone of the cooling unit is set to achieve a temperature of the chocolate mix of 36.5° C. The next zone is set at 29.7° C. Hence the temperature of the chocolate mix at the outlet is ideally about 30.3±0.1.

Following the cooling unit, the liquid chocolate mix at a temperature of ideally about 30.3±0.1, is fed to the aeration device. In the aeration device, an air stream is added to the chocolate mix stream at an ideal rate of under, or around half, that of the rate of addition of the chocolate mix. The combined air and chocolate mix are then mixed vigorously with a rotor-stator, the rotor moving at above about 49±1 revolutions per minute. The mixing chamber pressure is super-atmospheric and the pressure of the incoming air is greater than that of the mixing chamber.

The rotor-stator is cooled with 15° C.-25° C. (18.0±0.6° C.) jacketing water with the result the temperature of the aerated chocolate leaving the mixing chamber is about 30-32° C.

Following the mixing chamber, the aerated chocolate passes through jacketed pipework to a manifold, that can be manually altered to change the back-pressure to the mixing chamber.

From the manifold, the aerated chocolate mix is deposited onto chilled moulding rolls. The chilled moulding rolls turn at from about 400-700 revolutions per minute. The rolls are cooled with either water or a glycol-water mix, ideally in the range of about −18° C.±0.6, such that the ideal temperature of the chocolate leaving the rolls is between 5-16° C. A web of bi-convex, lenticular-shaped cores is formed.

The aerated moulded chocolate is then cooled in a cooling tunnel, typically using procedures known in the art.

The moulded chocolate then enters a rotating sieve, which removes the flashing from the bi-convex, lens-shaped chocolate cores.

Coating the Product

The smooth, correctly shaped product is then coated with a layer comprising sugar and water. The coating is done using any process equipment that can achieve a desired, even thickness of shell with an appropriate finished water activity (ideally around 0.25) in a commercially feasible time.

After this layer has dried, further layers comprising sugar and water may be applied, and dried, followed by layers comprising sugar, water and colours. After each layer has dried, further syrup is added, which completely covers the coated pieces, and then is dried. The desired finished shell percentage to chocolate percentage is achieved by repeating this step as many times as is required. The shell percentage will generally fall between 10%-50% by weight. The sugar shell completely covers the finished piece.

The finished product is then polished and different coloured finished pieces are blended together. Pieces may then have printed symbols added to their polished surface, before the product is packed out.

The finished bite size confection exhibits shelf stability even at elevated ambient temperatures. Tests show the product to be shelf stable even above 60° C.

### Comparative Example 1

The heat stability of confectionery products of the present invention was compared with the heat stability of confectionery products prepared by (1) the process described in International Application No. PCT/AU01/00452 and (2) Confectionery products made using non-aerated chocolate.

The testing method was as follows:

i) A convective airflow oven was set at a given temperature.

ii) A layer of ‘2 ply’ tissues was placed on top of an indented plate (a Perspex plate is often used).

iii) Product was placed on the plate such that trial and control product were evenly distributed over the plate.

iv) Each individual piece was weighed using a Metier Toledo Halogen Moisture Analyser (the scale part only). The location (on the plate) and weight of each piece was recorded. Also, it was noted if product was cracked before the test.

v) About 90 pieces were placed on the plate.

vi) Each piece was measured in height and diameter using a digital calliper (optional).

vii) A layer of ‘2 ply’ tissue was then placed on top of the product and a second plate placed on top. Care was taken to form the tissues around the pieces as close as possible (so if product did fat bleed, the fat would be absorbed by the tissue).

viii) The product and plate were then placed in the oven for a given duration. The temperature in the oven was logged using a Fluke II digital thermometer device.

ix) Product was taken from the oven and left to sit in ambient conditions for approximately ½ an hour (this was done to further allow fat to be absorbed by the tissues).

x) Each piece was then weighed and inspected (using a magnifying glass) for cracks and fat bleed.

This same test was carried out for the product of the present invention, the product of International Application No. PCT/AU01/00452 and prior art sugar coated confectionery products (M&M's) in which the chocolate was not aerated.

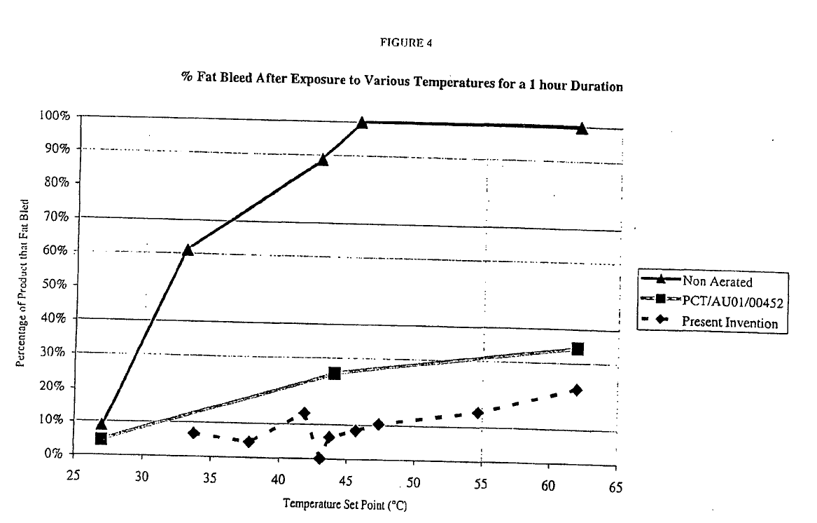

FIG. 4 is a graph showing the temperature (° C.—x axis) plotted against % Fat bleed (y axis).

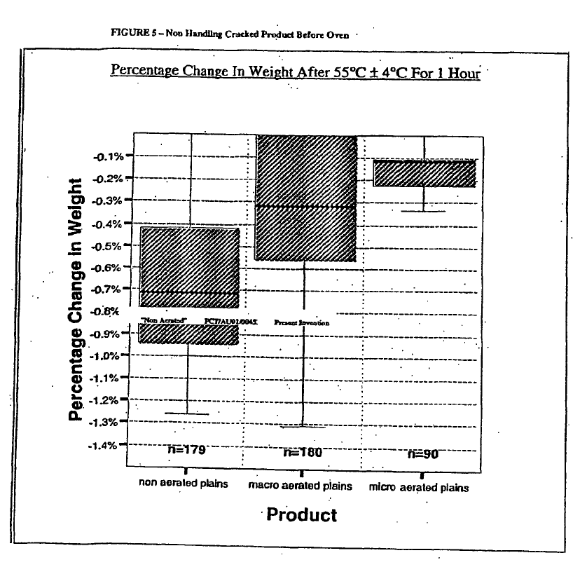

FIG. 5 is a “box and whisker” visual representation showing the % change in weight of non-aerated samples, samples of International Application No. PCT/AU01/00452 and the present invention at elevated temperature.

As can be seen from FIG. 4 the product of the present invention showed considerably lower fat bleed to both prior art products after 1 hour. Other tests showed that even after 17 and 24 hours the product of the present invention showed markedly better results than the two prior art products. Also, as can be seen from FIG. 5, the % change in weight of the product of the present invention at elevated temperatures is far lower than both other prior products.

1. A shelf-stable confectionery product having a chocolate core and a sugarbased, shell coating, wherein the chocolate core is dispersed with gas bubbles having an average diameter of less than 25 microns.

2. A shelf-stable confectionery product according to claim 1, wherein the average diameter of the gas bubbles is about 17 microns.

3. A shelf-stable confectionery product according to claim 1, wherein the gas bubbles are dispersed substantially homogenously throughout the chocolate core.

4. A shelf-stable confectionery product according to claim 1, wherein said gas is air.

5. A shelf-stable confectionery product according to claim 1, wherein the chocolate core comprises about 20-50% by weight cocoa fat, milk powder, sugar powder, liquid fat and flavour.

6. A shelf-stable confectionery product according to claim 1, wherein the sugar-based coating comprises at least one layer comprising sugar and water, coated with at least one layer comprising sugar, water and colour.

7. A shelf-stable confectionery product according to claim 1, which is bite-sized.

8. A process for making a shelf-stable confectionery product having a chocolate core and a sugar-based shell coating, the process comprising the steps (a) to (f), in the specified order:
a) preparing a pasty or liquid chocolate mix from solid chocolate making ingredients and at least one fat;
b) cooling said chocolate mix to form a cooled chocolate mix;
c) transferring said cooled chocolate mix into a mixing chamber;
d) in said mixing chamber, incorporating gas into said chocolate mix and stirring the chocolate mix to form a low density chocolate with micro eras bubbles having an average size no greater than a predetermined value;
e) extruding or otherwise depositing the low density chocolate onto one or more chilled moulding rolls and solidifying said low density chocolate into a desired shape; and
f) coating said moulded, low density chocolate with a sugar-based coating to form said shelf-stable confectionery product.

9. A process according to claim 8, wherein said gas is incorporated into said chocolate mix by rapid mixing of said chocolate mix together with said gas.

10. A process according to claim 8, wherein said rapid mixing is carried out by using a mixing head agitating the liquid chocolate mix.

11. A process according to claim 8, wherein step (b) comprises cooling the chocolate mix to about 30° C.

12. A process according to claim 8, wherein the low density chocolate is dispersed with gas bubbles having an average maximum size of less than 25 microns.

13. A process according to claim 12, wherein the average diameter is about 17 microns.

14. A process according to claim 12, wherein said gas bubbles are dispersed substantially homogeneously.

15. A process according to claim 8, wherein step (e) includes forming said low density chocolate into a slab of approximate constant thickness.

16. A panned confectionery product comprising a chocolate core and a sugarbased coating, wherein the product is produced by the method of claim 8.

17. A process of manufacturing aerated chocolate, wherein after a chocolate mixture has been formed by mixing solid chocolate making ingredients with at least one fat, the pasty or liquid chocolate mixture is transferred without undergoing a tempering step in a temper-kettle or similar device, into an aeration device with mechanical mixing means, wherein a gas is delivered to the aeration device where it is incorporated into the chocolate mixture, and wherein the chocolate mixture is agitated in the aeration device to achieve a predetermined (mean) maximum gas bubble size in the resulting aerated chocolate mixture prior to it being discharged from the aeration device for further processing.

18. The process of claim 17, wherein the chocolate mixture is agitated in the aeration device for a time so that it is discharged therefrom with said maximum gas bubble size being about 25 microns.

19. The process of claim 17, wherein the pasty or liquid chocolate mixture is cooled to a temperature of about 29° C.-31° C. before being delivered into the aeration device.

20. The process of claim 17, wherein the aerated chocolate mixture is maintained within the aeration device at a temperature of about 30° C.
